(19) United States
(12) Patent Application Publication
(10) Pub. No.: US 2009/0109062 A1
(43) Pub. Date: Apr. 30, 2009

(54) PARKING COUNT CONTROL SYSTEM USING PARKING MANAGEMENT SERVER AND METHOD THEREOF

(76) Inventor: Ik Song An, Incheon (KR)

Correspondence Address: IPLA P.A., 3580 WILSHIRE BLVD., 17TH FLOOR, LOS ANGELES, CA, 90010, US

(21) Appl. No.: 12/295,622

(22) PCT Filed: Mar. 29, 2007
(86) PCT No.: PCT/KR07/01539

§ 371 Date: Sep. 30, 2008

(30) Foreign Application Priority Data
Mar. 30, 2006 (KR) 10-2006-0029050
Mar. 29, 2007 (KR) PCT/KR2007/001539

(51) Int. Cl. G08G 1/14; H04W 4/00

(52) U.S. Cl. 340/932.2; 455/466

(57) ABSTRACT

Provided is a parking count control system using a parking management server which is a parking management control system using a driver terminal unit, the system including: a mobile driver terminal unit capable of performing voice communication or/and wireless Internet; a parking management server receiving parking information about an identifier (ID) of a parking area and a parking time from the driver terminal unit when the parking management server has an access to the driver terminal unit to perform settlement and counting a parking time according to a parking area to notify the driver terminal unit of a parking completion message; a parking terminal unit installed in the parking area or in a plurality of parking areas, receiving parking-related information transmitted from the parking management server to count and display a parking remaining time; and a settlement server connected to the parking management server and processing and authenticating parking-related small amount or credit settlement by request of the parking management server.

### TECHNICAL FIELD

The present invention relates to a parking management and settlement system, and more particularly, to a parking count control system using a parking management server which allows a driver himself/herself to have an access to the parking management server using a mobile phone during a parking operation, provides a parking-related guide to the driver to allow the driver himself/herself to settle a parking fee according to a parking expected time so that parking and parking fee settlement can be carried out conveniently and efficiently without the aid of a parking manager, and a method thereof.

### BACKGROUND ART

In general, a state-operated or city-operated parking lot (so-called an outside-the-road parking lot) that is operated with fees is the form in which a circuit breaker is located at the entrance of a parking lot and a parking manager carries out a parking management work. In addition, in case of an on-the-road parking lot disposed on the side of the road, the circuit breaker cannot be installed and the on-the-road parking lot operated only with parking manager's efforts.

However, in such a conventional parking system, voluntariness of the parking manager is high and there are continuous disputes related to parking fees. In addition, a parking fee which is a small amount mainly in units of several hundred won to several thousand won causes the parking manager to be inconvenient due to giving of change.

Furthermore, in the on-the-road parking lot, there are cases where there is a non-payment car in which a driver does not settle a parking fee and escapes while the parking manager leaves his/her place or does not give attention to the parking lot for a while.

In addition, in the prior art, a standable flap is installed in each parking region and only a parked car can be pulled out. However, there are problems on high costs for installation and safety.

Thus, in a variety of public parking lots or charged parking lots, the development of a system that minimizes installation of parking facilities and computerizes parking management clearly and efficiently is required.

To solve these problems, Korean Patent Registration No. 10-405917 like in FIG. 1 suggests a parking management method by which disputes related to parking fees are eliminated by computerizing the management of a charged parking lot, an on-the-road parking lot, and a local street parking lot.

FIG. 1 is a schematic view illustrating a conventional parking fee settlement system using a parking device and a personal digital assistants (PDA).

As illustrated in FIG. 1, a loop coil sensor 1 to determine whether a car is put into or pulled out is installed on the bottom of each parking area of a parking lot.

An output signal of the loop coil sensor 1 is concentrated on a parking device 3 installed at a corresponding on-the-road parking lot.

The parking device 3 has a similar structure to that of a personal computer (PC) including a central processing unit (CPU), RAM, a hard disc, LAN card, a wireless communication module, and a loop sensor interface. The wireless communication module transmits and receives data using a wireless LAN method and is mainly used for wireless data communication with a PDA 9 of a parking manager.

The parking device 3 is connected to a central server unit 7 through the Internet 5. The central server unit 7 is constituted to store data transmitted from a plurality of parking devices 3 installed in all areas of the city.

The PDA 9 is a mobile phone carried by a parking manager for managing a corresponding on-the-road parking lot and makes data communication with the parking devices 3. Since a wireless LAN module is stored in the PDA 9, bi-directional data communication with the parking devices 3 is possible.

Date, time, the name of a parking lot, the serial number of a parking area, a car number inputting screen, and a parking manager's name are displayed on the PDA 9 through a screen touch or a plurality of input buttons. A printer for outputting a receipt is installed on the lower end of the PDA 9.

In the prior art described above, if a car is put into the parking lot, the loop sensor 1 in a corresponding parking area causes a change in a magnetic field and outputs the change. An outputted signal is transmitted to the parking devices 3 and the parking devices 3 detect whether a car is put into the parking lot or not.

When it is detected that the car is put into the parking lot, the serial number of a corresponding parking area and year/month/date/hour/minute/second of a detected time is detected using a clock installed in the parking devices 3 and then, the data is transmitted to the PDA 9 through the wireless communication module and is transmitted to the central server unit 7 through the Internet 5.

The PDA 9 displays car-put-into data on a screen to allow the parking manager to recognize that the car is put into the parking lot. The parking manager reads the number of the put-into car with naked eyes and inputs the car number to the PDA 9.

The number of the car inputted to the PDA 9 is again transmitted to the parking devices 3, and the parking devices 3 transmit the transmitted car number as occasion demands to the central server unit 7. A car-put-into operation is completed through the above procedure.

After that, a customer has an access to his/her own car so as to pull out the car and calls the parking manager by signs. Next, if the parking manager inputs that the car is pulled out by inputting the serial number of the parking lot to his/her own PDA 9, the PDA 9 calculates a parking time from a difference between a car-put-into time and a car-pull-out time and multiplies a predetermined parking fee per minute to calculate the total parking time. If the calculated parking fee is notified to a driver of the car, the driver settles the parking fee and settlement is completed, a receipt is printed on the PDA 9.

In the conventional parking management and settlement system having the above structure, a loop sensor must be installed in each area of the parking lot and the parking devices 3 must be directly connected to the Internet. Thus, much time and costs are required for setting of a change in a general parking lot.

Furthermore, the parking manager himself/herself inputs parking information using the PDA 9 and carries out parking fee settlement and thus, transparency can be obtained. However, compared to the prior art, the burden of the parking manager is increased and parking management is considerably ineffective. In addition, there is a problem that parking fee settlement is considerably complicated.

### DISCLOSURE OF THE INVENTION

The present invention provides a parking count control system using a parking management server which allows a driver himself/herself to have an access to the parking management server using a mobile phone during a parking operation, provides a parking-related guide to the driver to allow the driver himself/herself to settle a parking fee according to a parking expected time so that parking and parking fee settlement can be carried out conveniently and efficiently without the aid of a parking manager, and a method thereof.

The present invention also provides a parking count control system using a parking management server which provides services only by installing one parking terminal unit in each parking area or in a plurality of parking areas of a parking lot so that installation of the parking lot and service start can be easily performed and investment costs can be minimized, and a method thereof.

The present invention also provides a parking count control system using a parking management server which, when a driver wants to extend a parking time during a parking operation, a parking management server can extend the parking time and make settlement using a driver's terminal unit so that management can be efficiently performed, and a method thereof.

According to an aspect of the present invention, there is provided a parking count control system using a parking management server which is a parking management control system using a driver terminal unit, the system comprising: a mobile driver terminal unit capable of performing voice communication or/and wireless Internet; a parking management server receiving parking information about an ID (identifier) of a parking area and a parking time from the driver terminal unit when the parking management server has an access to the driver terminal unit to perform settlement and counting a parking time according to a parking area to notify the driver terminal unit of a parking completion message; a parking terminal unit installed in the parking area or in a plurality of parking areas, receiving parking-related information transmitted from the parking management server to count and display a parking remaining time; and a settlement server connected to the parking management server and processing and authenticating parking-related small amount or credit settlement by request of the parking management server.

The parking management server may comprise: a call connection database in which an ID and a call connection number of the parking terminal unit installed in each parking area or in a plurality of parking areas of each parking lot are matched with each other and are written; a parking information database in which the ID of the parking terminal unit inputted through the driver terminal unit, a caller telephone number of the driver, and parking-related information are matched with one another and are stored; a communication unit performing amplification and conversion to be capable of making communication with the driver terminal unit through a predetermined wireless communication network; a communication interface capable of making communication with the settlement server; an SMS (short message service) generator generating an SMS message about a parking completion guide in the driver terminal unit; and a main processor guiding parking-related input information to a corresponding driver terminal unit when connecting to the driver terminal unit, if all of parking-related information is inputted from the driver terminal unit, controlling the entire system to make settlement according to a predetermined procedure and to transmit information including a parking time to a corresponding parking terminal unit.

The main processor may comprise: a CID (caller-ID) extractor extracting caller information of the driver terminal unit when connecting to the driver terminal unit; a parking guidance unit requesting and guiding information input such as an ID of the parking terminal unit, a parking time, and settlement when connecting to the driver terminal unit; and a timer counting a predetermined time, and if it is a parking completion time of each parking terminal unit, sending an SMS message.

The parking terminal unit may be installed in each parking area or in a plurality of parking areas of a parking lot, and an ID, an ARS (automatic response system) number or/and a wireless Internet address of the parking management server may be described at an outer surface of the parking terminal unit. The parking terminal unit may comprise: a receiver receiving parking-related information from the parking management server; a remaining time display unit displaying a parking remaining time base on an inputted expected parking time received from the receiver, a timer changing a time to be displayed on the remaining time display unit by counting the parking time; a parking completion notifying unit notifying an expiration state in visual and auditory senses according to a control signal if the parking time is expired; and a controlling unit storing parking-related information transmitted from the parking management server in memory and controlling to change and display a parking time through the remaining time display unit.

According to another aspect of the present invention, there is provided a parking count control method using a parking management server which is a parking management control method using a driver terminal unit, the method comprising: (a) if a driver terminal unit has an access to a parking management server through a predetermined wireless communication network, requesting to input an ID (identifier) of a parking terminal unit installed in each parking area; (b) if the ID of a corresponding parking terminal unit is inputted from the driver terminal unit, requesting the driver terminal unit to select an expected parking time using the parking management server; (c) if the expected parking time is inputted or selected from the driver terminal unit, guiding a parking fee corresponding to the expected parking time and performing small-amount settlement, credit settlement or other settlement method through a settlement server according to driver's selection; (d) if the settlement is completed, storing and managing a parking time and settlement information of the parking terminal unit corresponding to a parking area of the driver using the parking management server; (e) searching a call connection number matched with the ID of the parking terminal unit corresponding to the parking area of the driver through a database, call-connecting to the parking terminal unit, transmitting the parking time and counting a parking remaining time; and (f) displaying the parking time transmitted from the parking management server and counting a parking remaining time using the parking terminal unit.

If the driver terminal unit is connected in operation (a), the method may further comprise extracting and storing a caller telephone number. After performing (f), the method may further comprise checking a parking remaining time according to a parking terminal unit, generating an SMS message before an expiration time, and transmitting a message about parking completion to a corresponding driver terminal unit using the parking management server.

The message about parking completion may be a call-back message including parking time extension information. If the driver calls back according to parking time extension, the method may comprise: performing settlement by receiving a parking extension time from the driver terminal unit using the parking management server; if the settlement is completed, updating a parking time and settlement information using the parking management server; searching a call connection number corresponding to an ID of the parking terminal unit and then connecting to the parking terminal unit and transmitting a parking extension time using the parking management server; and displaying the parking extension time transmitted from the parking management server and re-counting a parking remaining time.

According to another aspect of the present invention, there is provided a parking count control method using a parking management server which is a parking management control method using a driver terminal unit, the method comprising: if a driver terminal unit is connected through a predetermined wireless communication network, extracting caller information and requesting to input an ID (identifier) of a parking terminal unit installed in each parking area or in a plurality of parking areas; if the ID of a corresponding parking terminal unit is inputted from the driver terminal unit, requesting to input a parking time to the driver terminal unit using the parking management server; if the parking time is inputted from the driver terminal unit, guiding a parking fee and performing small-amount settlement or credit settlement through a settlement server according to driver's selection; searching a call connection number corresponding to the ID of the parking terminal unit through a database, call-connecting to the parking terminal unit and transmitting the parking time using the parking management server; displaying the parking time transmitted from the parking management server and counting a parking remaining time using the parking terminal unit; and generating an SMS (short message service) message about parking completion and transmitting the SMS message to a corresponding driver terminal unit by receiving parking expiration information using the parking management server.

According to another aspect of the present invention, there is provided a parking count control method using a parking management server which is a parking management control method using a driver terminal unit, the method comprising: (a) if a driver terminal unit has an access to a parking management server through a predetermined wireless communication network, requesting to input an ID (identifier) of a parking terminal unit installed in a plurality of parking areas and the number of a corresponding parking area; (b) if the ID of a corresponding parking terminal unit and the number of the corresponding parking area are inputted from the driver terminal unit, requesting the driver terminal unit to select an expected parking time using the parking management server; (c) if the expected parking time is inputted or selected from the driver terminal unit, guiding a parking fee corresponding to the expected parking time and performing small-amount settlement, credit settlement or other settlement method through a settlement server according to driver's selection; (d) if the settlement is completed, storing and managing a parking time and settlement information of the parking terminal unit corresponding to a parking area of the driver using the parking management server; (e) searching a call connection number matched with the ID of the parking terminal unit corresponding to the parking area of the driver through a database, call-connecting to the parking terminal unit, transmitting the parking time and counting a parking remaining time using the parking management server; and (f) displaying the parking time transmitted from the parking management server and counting a parking remaining time using the parking terminal unit.

### BRIEF DESCRIPTION OF THE DRAWINGS

FIG. 1 illustrates a conventional parking fee settlement system using a parking device and a personal digital assistants (PDA).

FIG. 2 is a schematic view illustrating a parking count control system according to the present invention.

FIG. 3 is a functional block diagram illustrating a parking count control system according to an embodiment of the present invention.

FIGS. 4A and 4B are flowcharts illustrating all operations of the parking count control system illustrated in FIG. 2.

FIG. 5 is a schematic view illustrating a parking count control system according to another embodiment of the present invention.

FIGS. 6A and 6B are flowcharts illustrating all operations of the parking count control system illustrated in FIG. 5.

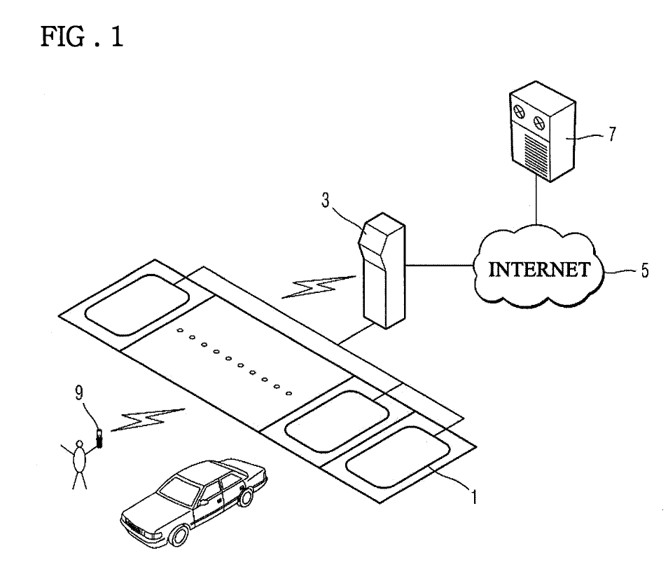

### BEST MODE FOR CARRYING OUT THE INVENTION

The present invention will now be described more fully with reference to the accompanying drawings, in which exemplary embodiments of the invention are shown.

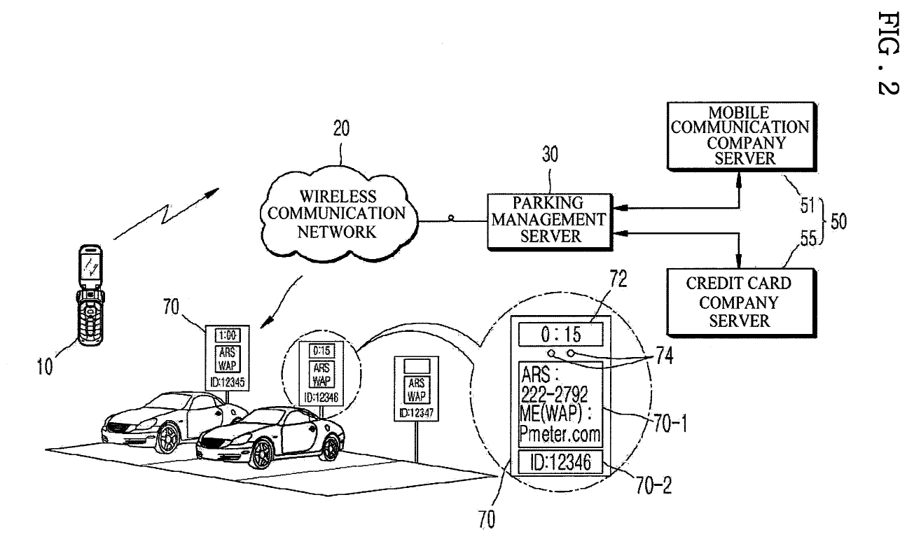

FIG. 2 is a schematic view illustrating a parking count control system according to the present invention. Referring to FIG. 2, the parking count control system comprises a driver terminal unit 10, a parking management server 30, a settlement server 50, and a parking terminal unit 70.

The deriver terminal unit 10 is a portable communication terminal unit such as a mobile phone, personal digital assistants (PDA) or hand-held personal computer (PC) using mobile cellular communication capable of performing voice communication or/and wireless Internet, IMT-2000, wireless LAN or a Wibro method. The parking management server 30 receives parking information about an identifier (ID) 70-2 of a parking area and a parking time from the driver terminal unit 10 when the parking management server 30 has an access to the driver terminal unit 10 to perform settlement and counts a parking time according to the parking terminal unit 70 to notify the driver terminal unit 10 of a parking completion message. The parking terminal unit 70 is installed in a parking area in which the car of the driver is parked, and receives driver's parking-related information transmitted from the parking management server 30 to count and display a parking remaining time. The settlement server 50 is connected to the parking management server 30 and comprises a server of a mobile communication company or credit card company for processing and authenticating parking-related small amount or credit settlement by request of the parking management server 30.

Furthermore, the parking terminal unit 70 is installed in each parking area of a parking lot. An identifier (ID) 70-2 of a parking area, that is, the parking terminal unit 70, and an automatic response system (ARS) or/and a wireless Internet address ME or WAP which is connection information 70-1 of the parking management server 30 is described at an outer surface of the parking terminal unit 70. The parking terminal unit 70 further comprises a remaining time display unit 72 such as a 7-segment or a liquid crystal display (LCD) displaying a parking remaining time at an upper end of the parking terminal unit 70 and a parking completion notifying unit 74 such as a light emitting diode (LED) displaying whether a parking time is expired or re-extended during a parking operation.

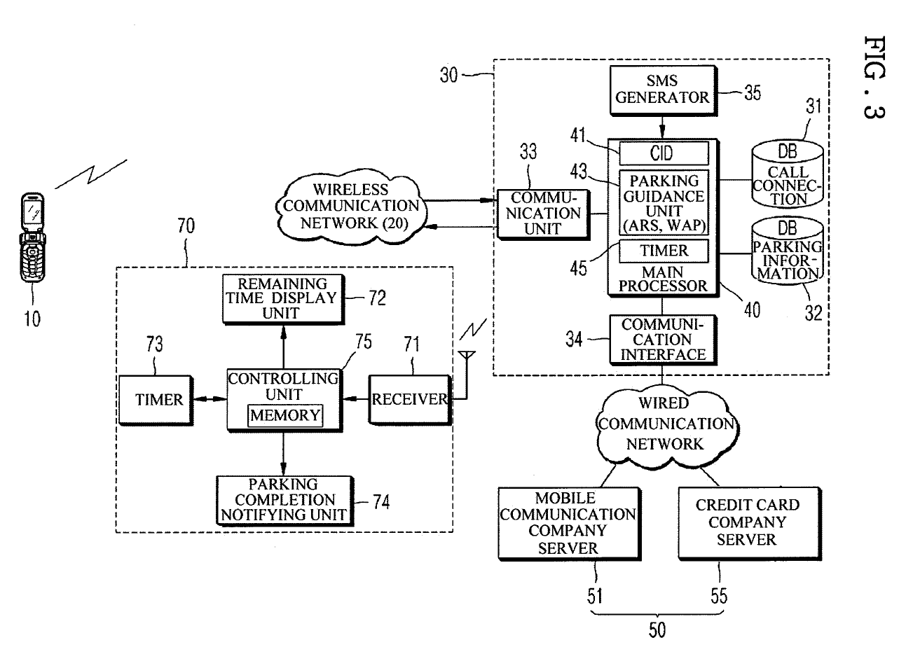

FIG. 3 is a functional block diagram illustrating a parking count control system according to an embodiment of the present invention. Referring to FIG. 3, the parking count control system comprises a driver terminal unit 10, a parking management server 30, a settlement server 50, and a parking terminal unit 70.

The driver terminal unit 10 is a portable communication terminal unit such as a mobile phone, a personal digital assistants (PDA) or hand-held personal computer (PC) using mobile cellular communication capable of performing voice communication or/and wireless Internet, IMT-2000, wireless LAN or a Wibro method. The parking management server 30 receives parking information about an identifier (ID) of a parking area and a parking time from the driver terminal unit 10 when the parking management server 30 has an access to the driver terminal unit 10 to perform settlement and counts a parking time according to a parking area to notify the driver terminal unit 10 of a parking completion message. The parking terminal unit 70 is installed in a parking area in which the car of the driver is parked, and receives driver's parking-related information transmitted from the parking management server 30 to count and display a parking remaining time. The settlement server 50 is connected to the parking management server 30 and comprises a system of a mobile communication company or credit card company for processing and authenticating parking-related small amount or credit settlement by request of the parking management server 30.

Furthermore, the parking management server 30 comprises a call connection database 31 in which an ID and a call connection number of the parking terminal unit 70 installed in each parking area or in a plurality of parking areas of each parking lot are matched with each other and are written, a parking information database 32 in which the ID of the parking terminal unit 70 inputted through the driver terminal unit 10, a caller telephone number of the driver, and parking-related information are matched with one another and are stored, a communication unit 33 performing amplification and conversion to be capable of making communication with the driver terminal unit 10 through a predetermined wireless communication network 20, a communication interface 34 capable of making communication with the settlement server 50, a short message service (SMS) generator 35 generating an SMS message about a parking completion guide in the driver terminal unit 10, and a main processor 40 guiding parking-related input information to a corresponding driver terminal unit 10 when connecting to the driver terminal unit 10, if all of parking-related information is inputted from the driver terminal unit 10, controlling the entire system to make settlement according to a predetermined procedure and to transmit information including a parking time to a corresponding parking terminal unit 70.

The main processor 40 comprises a caller-ID (CID) extractor 41 extracting caller information of the driver terminal unit 10 when connecting to the driver terminal unit 10, a parking guidance unit 43 requesting and guiding information input such as an ID of the parking terminal unit 70, a parking time, and settlement when connecting to the driver terminal unit 10, and a timer 45 counting a predetermined time, and if it is a parking completion time of each parking terminal unit 70, sending an SMS message.

In addition, the parking guidance unit 43 is an ARS transmitting a parking-related guide to the driver terminal unit 10 connecting to a mobile communication network via voice or a web service device transmitting the parking-related guide to the driver terminal unit 10 connecting to a wireless Internet via a web page.

Meanwhile, the parking terminal unit 70 comprises a receiver 71 receiving parking-related information from the parking management server 30, a remaining time display unit 72 displaying a parking remaining time based on an inputted expected parking time received from the receiver 71, a timer 73 changing a time to be displayed on the remaining time display unit 72 by counting the parking time, a parking completion notifying unit 74 notifying an expiration state in visual and auditory senses according to a control signal if the parking time is expired, and a controlling unit 75 storing parking-related information transmitted from the parking management server 30 in memory and controlling to change and display a parking time through the remaining time display unit 72.

Furthermore, the parking terminal unit 70 may be constituted to count a parking remaining time as occasion demands by constituting the receiver 71 as a transceiver to wirelessly notify parking expiration information of a corresponding parking area to the parking management server 30 before the parking remaining time is expired.

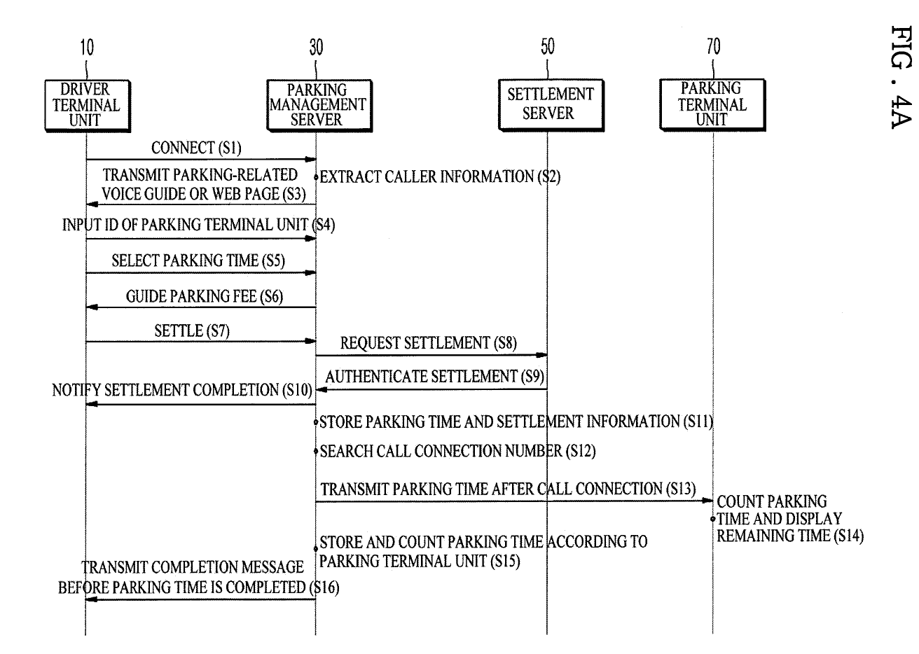

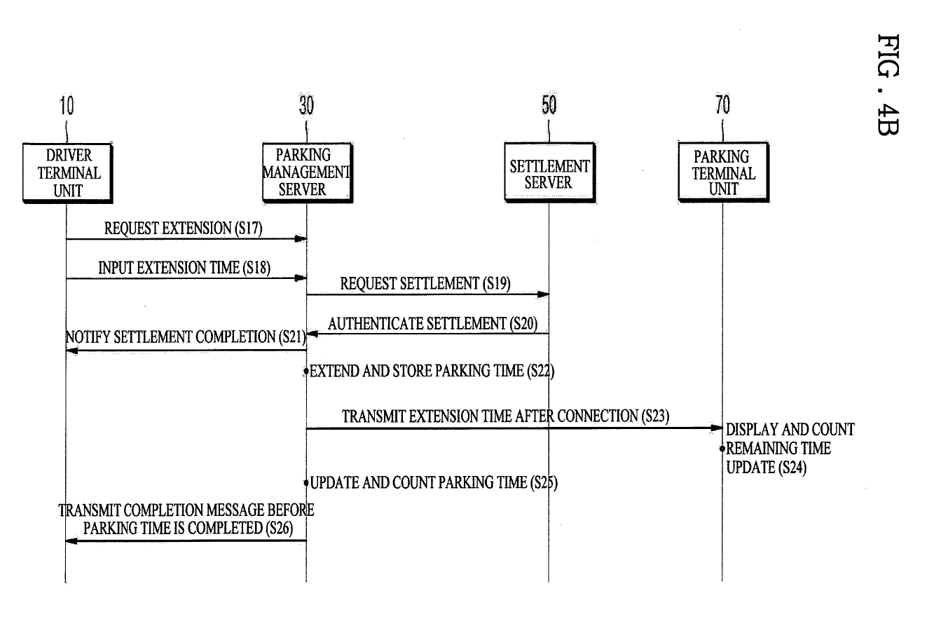

All operations of the parking count control system having the above structure will now be described with reference to FIGS. 4A and 4B.

First, a driver parks a car in each parking area of a parking lot and then checks an ID 70-2 and connection information 70-1 of the parking management server 30 described at the front side of the parking terminal unit 70 installed in a corresponding parking area.

According to the checking result of the connection information 70-2 of the parking management server 30, the driver connects to the parking management server 30 through a mobile communication network or a wireless communication network 20 such as the wireless Internet using own terminal unit 10 (S1).

Subsequently, the CID extractor 41 of the parking management server 30 extracts caller information (telephone number etc) of the driver terminal unit 10 connected through the wireless communication network 20 and stores the extracted caller information in the parking information database 32 (S2) and makes a predetermined parking-related guide to the driver terminal unit 10 via an ARS or a web page (S3).

First, the parking management server 30 requests the driver terminal unit 10 to input an ID of the parking terminal unit 70 installed in a parking area according to the operation of the parking guidance unit 43 if the driver terminal unit 10 is connected.

If the ID of the parking terminal unit 70 is inputted from the driver terminal unit 10, the parking guidance unit 43 request the driver terminal unit 10 to select an expected parking time, and if the expected parking time is selected from the driver terminal unit 10, the parking guidance unit 43 calculates a parking fee according to an expected parking time, guides the calculated parking fee to the driver terminal unit 10, and request instant settlement (S4, S5, and S6).

A settlement method is also guided when the settlement is requested. For example, a method of credit settlement using small-amount settlement using the driver terminal unit 10, a credit card or other settlement method is guided and a proper settlement method is selected according to driver's selection.

For example, when the driver selects small-amount settlement, the main processor 40 of the parking management server 30 requests the settlement server 50, that is, the mobile communication company server 51, of settlement, using a caller telephone number that has been previously extracted by the CID extractor 41 when connecting to the driver terminal unit 10, and the mobile communication company server 51 searches and determines whether the requested subscriber's settlement is authenticated or not and transmits the authentication result to the parking management server 30. As such, the parking management server 30 notifies settlement amount and settlement completion to the driver terminal unit 10 and completes a settlement procedure according to the notification (S7-S10). The small-amount or credit-settlement method follows a general settlement method using a mobile phone and thus, will not be described in detail.

Furthermore, the driver terminal unit 10 may receive a parking-related guide according to driver's selection via an ARS or a wireless Internet service when connecting to the parking management server 30, and the parking management server 30 makes a guide using an ARS voice guide or a web page according to driver's selection.

If the settlement according to a parking time is completed, the parking management server 30 stores caller information (telephone number of the driver terminal unit 10, a parking time, and settlement information according to the parking terminal unit 70 in the parking information database 32 (S11) and call-connects to the parking terminal unit 70 by searching a call connection number corresponding to the ID of the parking terminal unit 70 from the call connection database 31 (S12).

If the parking management server 30 transmits a parking time after call-connecting to the parking terminal unit 70 (S13), the parking terminal unit 70 displays the parking time on the remaining time display unit 72 and counts a remaining time using the timer 73 (S14). Of course, the parking management server 30 also transmits the parking time to the parking terminal unit 70 and then counts a remaining time according to the parking terminal unit 70 using the timer 45 (S15).

Subsequently, if the parking remaining time is not sufficient as the result of the parking time of the corresponding parking terminal unit 70 using the parking management server 30, the SMS generator 35 generates a short message indicating a parking completion remaining time and parking extension according to the request of the main processor 40 and outputs the generated short message to the main processor 40. The main processor 40 controls the entire system to transmit a call-back short message including a parking completion message to the driver terminal unit 10 using a previously-extracted caller telephone (S16).

As described above, the parking management server 30 is constituted to count the parking remaining time of the parking terminal unit 70 and to transmit a message (a message for checking the parking remaining time and parking extension) about parking completion to the driver terminal unit 10 when the parking time is expired. However, the receiver 71 of the parking terminal unit 70 may also be constituted as a transceiver, and if the parking remaining time is counted by the parking terminal unit 70 and the parking time is expired, the receiver 71 transmits the parking completion remaining time to the parking management server 30, writes a message about parking completion in the parking management server 30 to transmit the message to the deriver terminal unit 10.

Meanwhile, the driver selects a call-back function and re-connects to the parking management server 30 when seeing a parking completion message received through the driver terminal unit 10 and wanting to extend a parking time (S17).

Subsequently, if a parking time to be extended is re-inputted using the driver terminal unit 10 according to an ARS voice guide of the parking management server 30 (S18), the parking management server 30 performs a settlement authentication and recognition procedure through the corresponding settlement server 50 and notifies settlement completion to the driver terminal unit 10 and thereby a parking time is automatically extended (S19, S20, S21).

If the settlement according to the parking extension time is completed, the parking management server 30 updates and stores the parking extension time and settlement information in the parking information database 32 (S22) and searches a call connection number according to the ID of the parking terminal unit 70 from the call connection database 31 and call-connects to the parking terminal unit 70.

If the parking management server 30 call-interconnects to the parking terminal unit 70 and transmits the parking extension time (S23), the controlling unit 75 of the parking terminal unit 70 adds a current parking remaining time to the parking extension time, displays the added parking time on the remaining time display unit 72 and then counts a remaining time using the timer 45 (S24). Of course, the parking management server 30 also transmits a parking time to the parking terminal unit 70 and then again adds the parking remaining time to the parking extension time and counts a parking time (S25).

Subsequently, if the parking remaining time is not sufficient as the counting result of the parking time of the corresponding parking terminal unit 70, the SMS generator 35 generates a short message indicating a parking completion remaining time and parking extension according to the request of the main processor 40 and outputs the generated short message to the main processor 40, and the main processor 40 controls the entire system to transmit a call-back short message including a parking completion message to the driver terminal unit 10 using a previously-extracted caller telephone (S26).

Of course, although not illustrated, when a parking fee is not settled and a parking time has been elapsed, the parking terminal unit 70 may display a parking elapse time on the remaining time display unit 72 and to display the parking elapse time on the parking completion notifying unit 74 in visual and auditory senses so that the parking manager can take a proper action.

In addition, if a parking time is expired, the parking management server 70 may notify a corresponding parking manager or a police terminal unit of a corresponding area that a parking remaining time has been expired so that a parking manager or police can take a subsequent action.

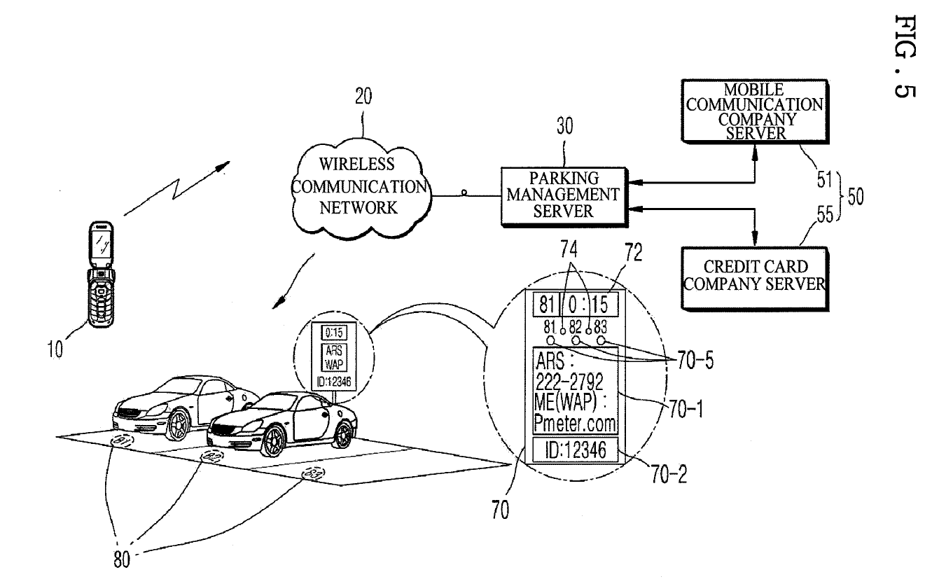

FIG. 5 is a schematic view illustrating a parking count control system according to another embodiment of the present invention. FIG. 5 is different from FIG. 2 in that one parking terminal unit 70 is installed in a plurality of parking areas and specific numbers 80 (for example, 81, 82, 83, . . . ) are allocated to each parking area and technical points of FIGS. 2 and 5 are the same.

In detail, a parking management server 30 receives parking information about an identifier (ID) 70-2 (80) of a parking area and a parking time from the driver terminal unit 10 when the parking management server 30 has an access to a driver terminal unit 10 to perform settlement and counts a parking time according to a parking area to notify the driver terminal unit 10 of a parking completion message. The parking terminal unit 70 is installed in a plurality of parking areas of a parking lot, receives driver's parking-related information transmitted from the parking management server 30 parked in the parking area to count and display a parking remaining time of each parking area separately.

In addition, when the parking terminal unit 70 is installed in a plurality of parking areas in this way, if the parking remaining time is displayed on the remaining time display unit 72 of the parking terminal unit 70, the remaining time of the parking area may be periodically repeatedly displayed together with the number 80 or 81 to 83 at predetermined intervals or a button 70-5 corresponding to each parking area is separately installed at the outer surface of the parking terminal unit 70 and if the parking manager presses a specific button 70-5, the parking remaining time of a parking area corresponding to the button 70-5 may be displayed.

Thus, when the parking terminal unit 70 is installed in a plurality of parking areas like in FIG. 5, the parking management server 30 counts and manages the parking time according to each parking area of the parking terminal unit 70. When the parking terminal unit 70 is installed in each parking area like in FIG. 2, the parking management server 30 counts and manages the parking time according to the parking terminal unit 70.

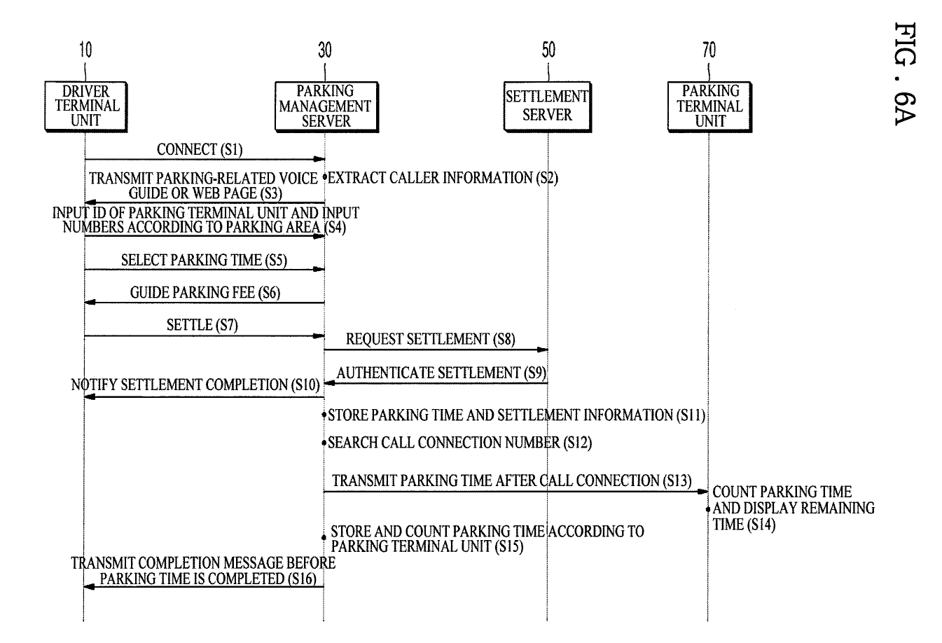

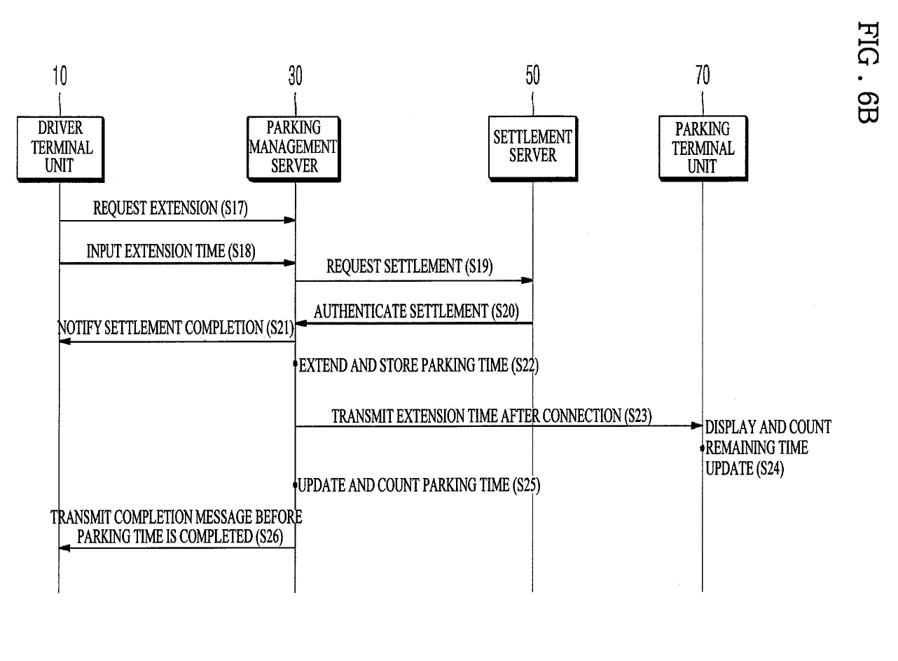

All operations of the parking count control system having the above structure of FIGS. 5 and 3 will now be described with reference to FIGS. 6A and 6B.

First, a driver parks a car in each parking area of a parking lot and then checks an ID 70-2, connection information 70-1 of the parking management server 30, and a specific number 80 according to a parking area described at the front side of the parking terminal unit 70 installed in a corresponding parking area.

According to the checking result of the connection information 70-2 of the parking management server 30, the driver connects to the parking management server 30 through a mobile communication network or a wireless communication network 20 such as the wireless Internet using own terminal unit 10 (S1).

Subsequently, the CID extractor 41 of the parking management server 30 extracts caller information (telephone number etc) of the driver terminal unit 10 connected through the wireless communication network 20 and stores the extracted caller information in the parking information database 32 (S2) and makes a predetermined parking-related guide to the driver terminal unit 10 via an ARS or a web page (S3).

First, the parking management server 30 requests the driver terminal unit 10 to input the ID 70-2 of the parking terminal unit 70 installed in a parking area according to the operation of the parking guidance unit 43 and the specific number 80 according to a parking area if the driver terminal unit 10 is connected.

If the ID 70-2 of the parking terminal unit 70 and the specific number 80 according to a parking area are inputted from the driver terminal unit 10, the parking guidance unit 43 request the driver terminal unit 10 to input an expected parking time, and if the expected parking time is inputted from the driver terminal unit 10, the parking guidance unit 43 calculates a parking fee according to an expected parking time, guides the calculated parking fee to the driver terminal unit 10, and request instant settlement (S4, S5, and S6).

A settlement method is also guided when the settlement is requested. For example, a method of credit settlement using small-amount settlement using the driver terminal unit 10, a credit card or other settlement method is guided and a proper settlement method is selected according to driver's selection.

For example, when the driver selects small-amount settlement, the main processor 40 of the parking management server 30 requests settlement to the settlement server 50, that is, the mobile communication company server 51, using a caller telephone number that has been previously extracted by the CID extractor 41 when connecting to the driver terminal unit 10, and the mobile communication company server 51 searches and determines whether the requested subscriber's settlement is authenticated or not and transmits the authentication result to the parking management server 30. As such, the parking management server 30 notifies settlement amount and settlement completion to the driver terminal unit 10 and completes a settlement procedure according to the notification (S7-S10). The small-amount or credit-settlement method follows a general settlement method using a mobile phone and thus, will not be described in detail.

Furthermore, the driver terminal unit 10 may receive a parking-related guide according to driver's selection via an ARS or a wireless Internet service when connecting to the parking management server 30, and the parking management server 30 makes a guide using an ARS voice guide or a web page according to driver's selection.

If the settlement according to a parking time is completed, the parking management server 30 stores caller information (telephone number of the driver terminal unit 10, a parking time, and settlement information according to a paring area 80 of the parking terminal unit 70 in the parking information database 32 (S11) and call-connects to the parking terminal unit 70 by searching a call connection number corresponding to the ID of the parking terminal unit 70 from the call connection database 31 (S12).

If the parking management server 30 transmits a parking area number and a parking time after call-connecting to the parking terminal unit 70 (S13), the parking terminal unit 70 displays the parking time on the remaining time display unit 72 and counts a remaining time using the timer 73 (S14). Of course, the parking management server 30 also transmits the parking time to the parking terminal unit 70 and then counts a remaining time according to the parking terminal unit 70 using the timer 45 (S15).

Subsequently, if the parking remaining time is not sufficient as the result of the parking time of the corresponding parking terminal unit 70 using the parking management server 30, the SMS generator 35 generates a short message indicating a parking completion remaining time and parking extension according to the request of the main processor 40 and outputs the generated short message to the main processor 40. The main processor 40 controls the entire system to transmit a call-back short message including a parking completion message to the driver terminal unit 10 using a previously-extracted caller telephone (S16).

As described above, the parking management server 30 is constituted to count the parking remaining time of the parking terminal unit 70 and to transmit a message (a message for checking the parking remaining time and parking extension) about parking completion to the driver terminal unit 10 when the parking time is expired. However, the receiver 71 of the parking terminal unit 70 may also be constituted as a transceiver, and if the parking remaining time is counted by the parking terminal unit 70 and the parking time is expired, the receiver 71 transmits the parking completion remaining time to the parking management server 30, writes a message about parking completion in the parking management server 30 to transmit the message to the deriver terminal unit 10.

Meanwhile, the driver selects a call-back function and re-connects to the parking management server 30 when seeing a parking completion message received through the driver terminal unit 10 and wanting to extend a parking time (S17).

Subsequently, if a parking time to be extended is re-inputted using the driver terminal unit 10 according to an ARS voice guide of the parking management server 30 (S18), the parking management server 30 performs a settlement authentication and recognition procedure through the corresponding settlement server 50 and notifies settlement completion to the driver terminal unit 10 and thereby a parking time is automatically extended (S19, S20, S21).

If the settlement according to the parking extension time is completed, the parking management server 30 updates and stores the parking extension time and settlement information in the parking information database 32 (S22) and searches a call connection number according to the ID of the parking terminal unit 70 from the call connection database 31 and call-connects to the parking terminal unit 70.

If the parking management server 30 call-interconnects to the parking terminal unit 70 and transmits the parking area number and the parking extension time (S23), the controlling unit 75 of the parking terminal unit 70 adds a current parking remaining time to the parking extension time, displays the added parking time on the remaining time display unit 72 and then counts a remaining time using the timer 45 (S24). Of course, the parking management server 30 also transmits a parking time to the parking terminal unit 70 and then again adds the parking remaining time to the parking extension time and counts a parking time (S25).

Subsequently, if the parking remaining time is not sufficient as the counting result of the parking time of a corresponding parking area of the parking terminal unit 70, the SMS generator 35 generates a short message indicating a parking completion remaining time and parking extension according to the request of the main processor 40 and outputs the generated short message to the main processor 40, and the main processor 40 controls the entire system to transmit a call-back short message including a parking completion message to the driver terminal unit 10 using a previously-extracted caller telephone (S26).

Of course, although not illustrated, when a parking fee is not settled and a parking time has been elapsed, the parking terminal unit 70 may display a parking elapse time according to a parking area on the remaining time display unit 72 and to display the parking elapse time on the parking completion notifying unit 74 in visual senses so that the parking manager can take a proper action.

In addition, if a parking time is expired, the parking management server 70 may notify a corresponding parking manager or a police terminal unit of a corresponding area that a parking remaining time has been expired so that a parking manager or police can take a subsequent action.

Parking management is performed and a parking fee is settled through the above-described procedure such that the driver himself/herself has an access to the parking management server to settle the parking fee, and when a parking time is expired, parking expiration information and parking extension are notified to the driver such that parking and parking extension are easily performed and the role of the parking manager is minimized and thus is effective.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, a driver himself/herself has an access to a parking management server using a mobile phone during a parking operation and a parking-related guide is provided to the driver to allow the driver himself/herself to settle a parking fee according to a parking expected time such that parking and parking fee settlement are considerably conveniently and efficiently performed without the aid of a parking manager.

Furthermore, services are provided only by installing one parking terminal unit in each parking area or in a plurality of parking areas of a parking lot such that installation of the parking lot and service start are easily performed and investment costs are minimized. In addition, the parking management server transmits a call-back text message to the driver before parking is completed such that, when the driver wants to extend a parking time, extension and settlement can be performed using a call-back function and considerably efficient and convenient services can be provide to the driver.

1. A parking count control system using a parking management server which is a parking management control system using a driver terminal unit, the system comprising:
a mobile driver terminal unit capable of performing voice communication or/and wireless Internet;
a parking management server receiving parking information about an ID (identifier) of a parking area and a parking time from the driver terminal unit when the parking management server has an access to the driver terminal unit to perform settlement and counting a parking time according to a parking area to notify the driver terminal unit of a parking completion message;
a parking terminal unit installed in the parking area or in a plurality of parking areas, receiving parking-related information transmitted from the parking management server to count and display a parking remaining time; and
a settlement server connected to the parking management server and processing and authenticating parking-related small amount or credit settlement by request of the parking management server.

2. The system of claim 1, wherein the parking management server comprises:
a call connection database in which an ID and a call connection number of the parking terminal unit installed in each parking area or in a plurality of parking areas of each parking lot are matched with each other and are written;
a parking information database in which the ID of the parking terminal unit inputted through the driver terminal unit, a caller telephone number of the driver, and parking-related information are matched with one another and are stored;
a communication unit performing amplification and conversion to be capable of making communication with the driver terminal unit through a predetermined wireless communication network;
a communication interface capable of making communication with the settlement server;
an SMS (short message service) generator generating an SMS message about a parking completion guide in the driver terminal unit; and
a main processor guiding parking-related input information to a corresponding driver terminal unit when connecting to the driver terminal unit, if all of parking-related information is inputted from the driver terminal unit, controlling the entire system to make settlement according to a predetermined procedure and to transmit information including a parking time to a corresponding parking terminal unit.

3. The system of claim 2, wherein the main processor comprises:
a CID (caller-ID) extractor extracting caller information of the driver terminal unit when connecting to the driver terminal unit;
a parking guidance unit requesting and guiding information input such as an ID of the parking terminal unit, a parking time, and settlement when connecting to the driver terminal unit; and
a timer counting a predetermined time, and if it is a parking completion time of each parking terminal unit, sending an SMS message.

4. The system of claim 1, wherein the parking terminal unit is installed in each parking area or in a plurality of parking areas of a parking lot, and an ID, an ARS (automatic response system) number or/and a wireless Internet address of the parking management server is described at an outer surface of the parking terminal unit.

5. The system of claim 1, wherein the parking terminal unit comprises:
a receiver receiving parking-related information from the parking management server;
a remaining time display unit displaying a parking remaining time base on an inputted expected parking time received from the receiver;
a timer changing a time to be displayed on the remaining time display unit by counting the parking time;
a parking completion notifying unit notifying an expiration state in visual and auditory senses according to a control signal if the parking time is expired; and
a controlling unit storing parking-related information transmitted from the parking management server in memory and controlling to change and display a parking time through the remaining time display unit.

6. The system of claim 5, wherein the receiver of the parking terminal unit is a transceiver receiving parking-related information from a parking management server and transmitting parking expiration information to the parking management sever before the parking remaining time counted in each parking area is expired.

7. A parking count control method using a parking management server which is a parking management control method using a driver terminal unit, the method comprising:
(a) if a driver terminal unit has an access to a parking management server through a predetermined wireless communication network, requesting to input an ID (identifier) of a parking terminal unit installed in each parking area;
(b) if the ID of a corresponding parking terminal unit is inputted from the driver terminal unit, requesting the driver terminal unit to select an expected parking time using the parking management server;
(c) if the expected parking time is inputted or selected from the driver terminal unit, guiding a parking fee corresponding to the expected parking time and performing small-amount settlement, credit settlement or other settlement method through a settlement server according to driver's selection;
(d) if the settlement is completed, storing and managing a parking time and settlement information of the parking terminal unit corresponding to a parking area of the driver using the parking management server;
(e) searching a call connection number matched with the ID of the parking terminal unit corresponding to the parking area of the driver through a database, call-connecting to the parking terminal unit, transmitting the parking time and counting a parking remaining time; and
(f) displaying the parking time transmitted from the parking management server and counting a parking remaining time using the parking terminal unit.

8. The method of claim 7, if the driver terminal unit is connected in operation (a), further comprising extracting and storing a caller telephone number.

9. The method of claim 7, after performing (f), further comprising checking a parking remaining time according to a parking terminal unit, generating an SMS message before an expiration time, and transmitting a message about parking completion to a corresponding driver terminal unit using the parking management server.

10. The method of claim 9, wherein the message about parking completion is a call-back message including parking time extension information.

11. The method of claim 9, if the driver calls back according to parking time extension, comprising:
performing settlement by receiving a parking extension time from the driver terminal unit using the parking management server;
if the settlement is completed, updating a parking time and settlement information using the parking management server;
searching a call connection number corresponding to an ID of the parking terminal unit and then connecting to the parking terminal unit and transmitting a parking extension time using the parking management server; and
displaying the parking extension time transmitted from the parking management server and re-counting a parking remaining time.

12. A parking count control method using a parking management server which is a parking management control method using a driver terminal unit, the method comprising:
if a driver terminal unit is connected through a predetermined wireless communication network, extracting caller information and requesting to input an ID (identifier) of a parking terminal unit installed in each parking area or in a plurality of parking areas;
if the ID of a corresponding parking terminal unit is inputted from the driver terminal unit, requesting to input a parking time to the driver terminal unit using the parking management server;
if the parking time is inputted from the driver terminal unit, guiding a parking fee and performing small-amount settlement or credit settlement through a settlement server according to driver's selection;
searching a call connection number corresponding to the ID of the parking terminal unit through a database, call-connecting to the parking terminal unit and transmitting the parking time using the parking management server;
displaying the parking time transmitted from the parking management server and counting a parking remaining time using the parking terminal unit; and
generating an SMS (short message service) message about parking completion and transmitting the SMS message to a corresponding driver terminal unit by receiving parking expiration information using the parking management server.

13. A parking count control method using a parking management server which is a parking management control method using a driver terminal unit, the method comprising:
(a) if a driver terminal unit has an access to a parking management server through a predetermined wireless communication network, requesting to input an ID (identifier) of a parking terminal unit installed in a plurality of parking areas and the number of a corresponding parking area;
(b) if the ID of a corresponding parking terminal unit and the number of the corresponding parking area are inputted from the driver terminal unit, requesting the driver terminal unit to select an expected parking time using the parking management server;
(c) if the expected parking time is inputted or selected from the driver terminal unit, guiding a parking fee corresponding to the expected parking time and performing small-amount settlement, credit settlement or other settlement method through a settlement server according to driver's selection;
(d) if the settlement is completed, storing and managing a parking time and settlement information of the parking terminal unit corresponding to a parking area of the driver using the parking management server;
(e) searching a call connection number matched with the ID of the parking terminal unit corresponding to the parking area of the driver through a database, call-connecting to the parking terminal unit, transmitting the parking time and counting a parking remaining time using the parking management server; and
(f) displaying the parking time transmitted from the parking management server and counting a parking remaining time using the parking terminal unit.

14. The system of claim 4, wherein the parking terminal unit comprises:
a receiver receiving parking-related information from the parking management server;
a remaining time display unit displaying a parking remaining time base on an inputted expected parking time received from the receiver;
a timer changing a time to be displayed on the remaining time display unit by counting the parking time;
a parking completion notifying unit notifying an expiration state in visual and auditory senses according to a control signal if the parking time is expired; and
a controlling unit storing parking-related information transmitted from the parking management server in memory and controlling to change and display a parking time through the remaining time display unit.

15. The method of claim 8, after performing (f), further comprising checking a parking remaining time according to a parking terminal unit, generating an SMS message before an expiration time, and transmitting a message about parking completion to a corresponding driver terminal unit using the parking management server.
